(19) United States
(12) Patent Application Publication
(10) Pub. No.: US 2018/0003340 A1
(43) Pub. Date: Jan. 4, 2018

(54) Two-axis gimbal and three-axis gimbal

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/708,103

(22) Filed: Sep. 18, 2017

(30) Foreign Application Priority Data
Jan. 23, 2017 (CN) 201710058853.4
Jan. 23, 2017 (CN) 201710059066.1
Jan. 23, 2017 (CN) 201710059067.6
Jan. 23, 2017 (CN) 201710059075.0
Jan. 23, 2017 (CN) 201720103681.3
Jan. 23, 2017 (CN) 201720103728.6

(51) Int. Cl. F16M 13/02; H02K 7/14; G03B 17/56; F16M 11/18; F16M 11/10; H02K 16/00; H02K 11/33

(52) U.S. Cl. CPC F16M 13/022; H02K 16/00; H02K 7/14; H02K 11/33; F16M 11/18; F16M 11/10; G03B 17/561

(57) ABSTRACT

A three-axis gimbal includes a carrier, a first fixing frame, a second fixing frame, a third fixing frame, a first motor, a second motor and a third motor. The first motor is connected respectively with the first fixing frame and the second fixing frame, so that the second fixing frame rotates relative to the first fixing frame. The second motor is connected respectively with the second fixing frame and the third fixing frame, so that the third fixing frame rotates relative to the second fixing frame. The third motor is connected respectively with the third fixing frame and the carrier, so that the carrier rotates relative to the third fixing frame. An axis of the second motor is parallel to an axis of the carrier; an axis of the third motor is perpendicular to the first fixing frame; axes of the three motors are perpendicular to each other.

### CROSS REFERENCE OF RELATED APPLICATION

The application claims priority under 35 U.S.C. 119(a-d) to CN 201710058853.4, CN 201710059066.1, CN 201710059067.6, CN 201710059075.0, CN 201720103681.3 and CN 201720103728.6, all filed Jan. 23, 2017.

### BACKGROUND OF THE PRESENT INVENTION

### Field of Invention

The present invention relates to a two-axis gimbal and a three-axis gimbal.

### Description of Related Arts

The gimbal is a support device for mounting and fixing the camera. According to the rotational degree of freedom, the conventional gimbal can be divided into two-axis gimbal, three-axis gimbal and other types. However, when involving the connection of multiple motors, the gimbal such as the two-axis gimbal and the three-axis gimbal has following problems.

Firstly, the gimbal has a large volume and a heavy weight.

Secondly, the arrangement of the internal wiring is too complex, which is not beneficial to production.

Thirdly, the stacking order is improper, causing the increased control difficulty and the poor image stability.

### SUMMARY OF THE PRESENT INVENTION

An object of the present invention is to provide a two-axis gimbal, so as to overcome defects of large volume, heavy weight and improper stacking of a conventional gimbal in prior art.

The above technical problems are solved by the present invention through following technical solutions.

A two-axis gimbal comprises a carrier, a first fixing frame, a second fixing frame, a first motor and a second motor, wherein:

the first motor is connected respectively with the first fixing frame and the second fixing frame, and is configured to drive the second fixing frame to rotate relative to the first fixing frame;

the second motor is connected respectively with the second fixing frame and the carrier, and is configured to drive the carrier to rotate relative to the second fixing frame; and

an axis of the second motor is parallel to an axis of the carrier, and an axis of the first motor is perpendicular to the axis of the second motor.

Through an arrangement of the first motor and the second motor, the present invention increases a stability of the carrier.

Preferably, the first fixing frame comprises a base and an extension arm perpendicular to the base, wherein: the first motor is connected with the extension arm; the carrier and the second motor are located below the base; and the axis of the first motor is parallel to the base.

Preferably, the axis of the second motor and the axis of the carrier are coaxial.

Preferably, the carrier is a camera unit.

Preferably, the axis of the first motor is located in a horizontal plane.

Preferably, a stator of the first motor is connected with the first fixing frame, and a rotor of the first motor is connected with the second fixing frame; a stator of the second motor is connected with the second fixing frame, and a rotor of the second motor is connected with the carrier.

Preferably, the two-axis gimbal further comprises a first magnetic-control board and a second magnetic-control board, wherein:

the first motor and the first magnetic-control board are fixed at two sides of the first fixing frame; and

the second motor and the second magnetic-control board are fixed at two sides of the second fixing frame.

Preferably, a control board is arranged on the first fixing frame; the carrier, the control board, the first magnetic-control board and the second magnetic-control board are electrically connected through a flexible printed circuit board.

On the basis of conforming to the common sense in the art, the above optimized conditions can be combined in any form, so that preferred embodiments of the present invention are obtained.

The present invention has following positive effects that: through an application of the present invention, a thickness of the two-axis gimbal in a vertical direction is effectively decreased, and therefore a volume and a weight of the gimbal are decreased, which is beneficial to a control of the two-axis gimbal and increases a shooting stability.

Another object of the present invention is to provide a three-axis gimbal, so as to overcome the defects of large volume, heavy weight and improper stacking of the conventional gimbal in the prior art.

The above technical problems are solved by the present invention through following technical solutions.

A three-axis gimbal comprises a carrier, a first fixing frame, a second fixing frame, a third fixing frame, a first motor, a second motor and a third motor, wherein:

the first motor is connected respectively with the first fixing frame and the second fixing frame, and is configured to drive the second fixing frame to rotate relative to the first fixing frame;

the second motor is connected respectively with the second fixing frame and the third fixing frame, and is configured to drive the third fixing frame to rotate relative to the second fixing frame;

the third motor is connected respectively with the third fixing frame and the carrier, and is configured to drive the carrier to rotate relative to the third fixing frame; and

an axis of the second motor is parallel to an axis of the carrier, and an axis of the third motor is perpendicular to the first fixing frame; an axis of the first motor, the axis of the second motor and the axis of the third motor are perpendicular to each other.

Through an arrangement of the first motor, the second motor and the third motor, the present invention increases a stability of the carrier.

Preferably, the first fixing frame comprises a base and an extension arm perpendicular to the base, wherein the first motor is connected with the extension arm.

Preferably, the axis of the third motor is perpendicular to the base.

Preferably, the carrier is a camera unit.

Preferably, the axis of the second motor and the axis of the carrier are coaxial.

Preferably, the axis of the first motor is located in a horizontal plane.

Preferably, the axis of the first motor is perpendicular to the horizontal plane.

Preferably, a stator of the first motor is connected with the first fixing frame, and a rotor of the first motor is connected with the second fixing frame; a stator of the second motor is connected with the second fixing frame, and a rotor of the second motor is connected with the third fixing frame; a stator of the third motor is connected with the third fixing frame, and a rotor of the third motor is connected with the carrier.

Preferably, a protective casing covers outer sides of the carrier and the third motor.

Preferably, the three-axis gimbal further comprises a first magnetic-control board, a second magnetic-control board and a third magnetic-control board, wherein:

the first motor and the first magnetic-control board are fixed at two sides of the first fixing frame;

the second motor and the second magnetic-control board are fixed at two sides of the second fixing frame; and

the third motor and the third magnetic-control board are fixed at two sides of the third fixing frame.

Preferably, a control board is arranged on the first fixing frame; the carrier, the control board, the first magnetic-control board, the second magnetic-control board and the third magnetic-control board are electrically connected through a flexible printed circuit board.

On the basis of conforming to the common sense in the art, the above optimized conditions can be combined in any form, so that preferred embodiments of the present invention are obtained.

The present invention has following positive effects that: through an application of the present invention, a thickness of the three-axis gimbal in a vertical direction is effectively decreased, and therefore a volume and a weight of the gimbal are decreased, which is beneficial to a control of the three-axis gimbal.

### BRIEF DESCRIPTION OF THE DRAWINGS

FIG. 1 is an exploded view of a three-axis gimbal according to a first preferred embodiment of the present invention.

FIG. 2 is a perspective view of the three-axis gimbal with a protective casing according to the first preferred embodiment of the present invention.

FIG. 3 is a perspective view of the three-axis gimbal according to the first preferred embodiment of the present invention.

FIG. 4 is a right view of the three-axis gimbal according to the first preferred embodiment of the present invention.

FIG. 5 is a front view of the three-axis gimbal according to the first preferred embodiment of the present invention.

FIG. 6 is a top view of the three-axis gimbal according to the first preferred embodiment of the present invention.

FIG. 7 is a perspective view of a three-axis gimbal according to a second preferred embodiment of the present invention.

FIG. 8 is a front view of the three-axis gimbal according to the second preferred embodiment of the present invention.

FIG. 9 is a right view of the three-axis gimbal according to the second preferred embodiment of the present invention.

FIG. 10 is a top view of the three-axis gimbal according to the second preferred embodiment of the present invention.

FIG. 11 is an exploded view of a two-axis gimbal according to a third preferred embodiment of the present invention.

FIG. 12 is a perspective view of the two-axis gimbal according to the third preferred embodiment of the present invention.

FIG. 13 is a right view of the two-axis gimbal according to the third preferred embodiment of the present invention.

FIG. 14 is a front view of the two-axis gimbal according to the third preferred embodiment of the present invention.

FIG. 15 is a top view of the two-axis gimbal according to the third preferred embodiment of the present invention.

Reference characters in figures are introduced as follows.

| | | | |
|---|---|---|---|
| First motor | 11 | Stator of first motor | 111 |
| Rotor of first motor | 112 | Second motor | 12 |
| Stator of second motor | 121 | Rotor of second motor | 122 |
| Third motor | 13 | Stator of third motor | 131 |
| Rotor of third motor | 132 | First fixing frame | 21 |
| Base | 211 | Extension arm | 212 |
| Second fixing frame | 22 | Third fixing frame | 23 |
| Carrier | 3 | First magnetic- | 41 |
| | | control board | |
| Second magnetic- | 42 | Third magnetic- | 43 |
| control board | | control board | |
| Control board | 5 | Protective casing | 6 |
| Axis | X | Axis | Y |
| Axis | Z | Plane | P |
| Plane | M | | |

### DETAILED DESCRIPTION OF THE PREFERRED EMBODIMENT

The present invention is further described with following preferred embodiments, but will not be limited in the scope of the preferred embodiments.

### First Preferred Embodiment

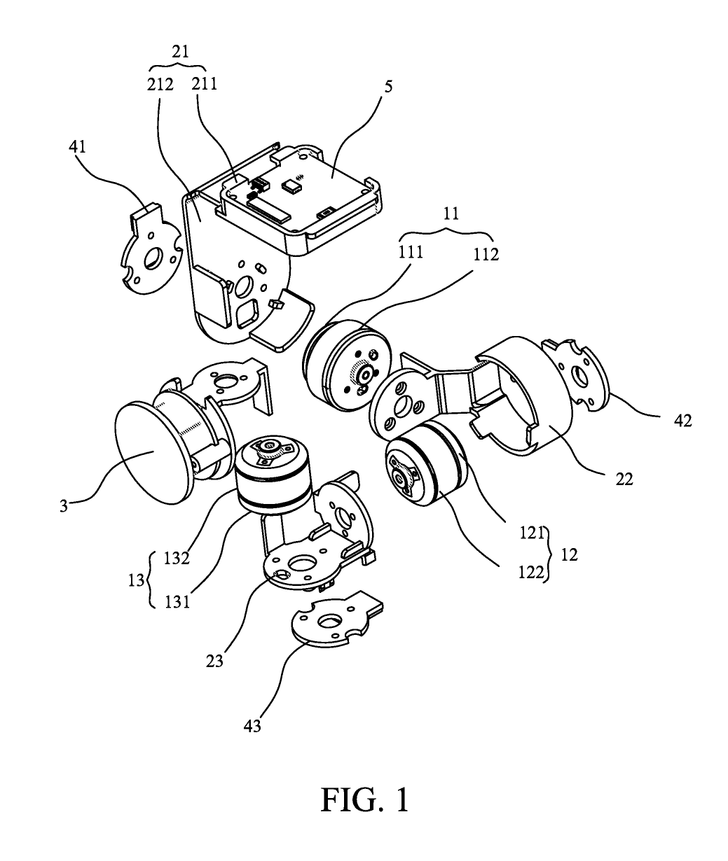

Referring to FIG. 1-FIG. 6, according to a first preferred embodiment, the present invention provides a three-axis gimbal, comprising a carrier 3, a first fixing frame 21, a second fixing frame 22, a third fixing frame 23, a first motor 11, a second motor 12 and a third motor 13.

As shown in FIG. 1, the first motor 11 is connected respectively with the first fixing frame 21 and the second fixing frame 22, and is configured to drive the second fixing frame 22 to rotate relative to the first fixing frame 21; the second motor 12 is connected respectively with the second fixing frame 22 and the third fixing frame 23, and is configured to drive the third fixing frame 23 to rotate relative to the second fixing frame 22; and, the third motor 13 is connected respectively with the third fixing frame 23 and the carrier 3, and is configured to drive the carrier 3 to rotate relative to the third fixing frame 23.

As shown in FIG. 3, through the first motor 11, a rotation around an axis “X” of the first motor 11 is realized; through the second motor 12, a rotation around an axis “Y” of the second motor 12 is realized; and, through the third motor 13, a rotation around an axis “Z” of the third motor 13 is realized.

As shown in FIG. 3, the axis “X” of the first motor 11, the axis “Y” of the second motor 12 and the third axis “Z” of the third motor 13 are perpendicular to each other. The axis “Y” of the second motor 12 is parallel to an axis of the carrier 3, and the axis “Z” of the third motor 13 is perpendicular to the first fixing frame 21. Preferably, the axis “Y” of the second motor 12 and the axis of the carrier 3 are coaxial. Through the above arrangement of the first motor 11, the second motor 12 and the third motor 13, a stability of the carrier 3 is improved. When the carrier 3 is a camera unit, a shooting stability is greatly increased.

As shown in FIG. 1, a conventional motor comprises a stator and a rotor. According to the first preferred embodiment, a stator 111 of the first motor 11 is connected with the first fixing frame 21, and a rotor 112 of the first motor 11 is connected with the second fixing frame 22. A relative rotation generates between the stator 111 and the rotor 112, so as to drive the second fixing frame to rotate.

A stator 121 of the second motor 12 is connected with the second fixing frame 22, and a rotor 122 of the second motor 12 is connected with the third fixing frame 23. A relative rotation generates between the stator 121 and the rotor 122, so as to drive the third fixing frame to rotate.

A stator 131 of the third motor 13 is connected with the third fixing frame 23, and a rotor 132 of the third motor 13 is connected with the carrier 3. A relative rotation generates between the stator 131 and the rotor 132, so as to drive the carrier 3 to rotate.

As shown in FIG. 3, the first motor 11, the second motor 12 and the third motor 13 are arranged in a same plane “P”, wherein the first motor 11, the second motor 12 and the third motor 13 can have slight deviation in a vertical direction as long as main bodies of the first motor 11, the second motor 12 and the third motor 13 are guaranteed to be located in the same plane “P”.

Through arranging the first motor 11, the second motor 12 and the third motor 13 in the same plane, stacking of the first motor 11, the second motor 12 and the third motor 13 in the vertical direction is avoided, which effectively reduces a thickness of the three-axis gimbal in the vertical direction. Therefore, a volume and a weight of the gimbal are decreased, which is beneficial to a control of the three-axis gimbal.

As shown in FIG. 3, according to the first preferred embodiment, the axis “X” of the first motor 11 is perpendicular to the axis “Y” of the second motor 12, and the two axes are located in the same plane “P”, so as to realize the rational arrangement of the axis “X” of the first motor 11 and the axis “Y” of the second motor 12, eliminate a distance deviation of the planes where the two axes are located and reduce a control difficulty of the motors. The axis “Z” of the third motor 13 is perpendicular to the plane “P”.

Preferably, the axis “X” of the first motor 11 is located in a horizontal plane. Under an initial state, the plane “P” is namely the horizontal plane. The axis “X” of the first motor 11 is arranged to be located in the horizontal plane, that is to say both of the axis “X” and the axis “Y” are initially arranged horizontally, which simplifies a coordinate system and reduces the control difficulty of the motors.

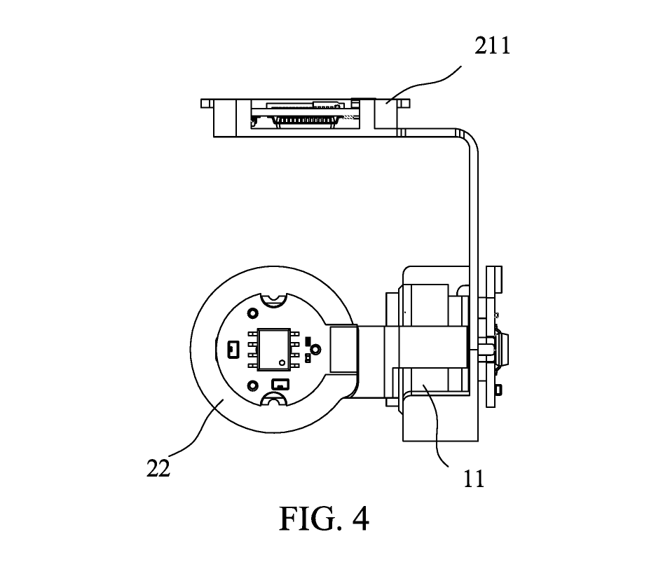

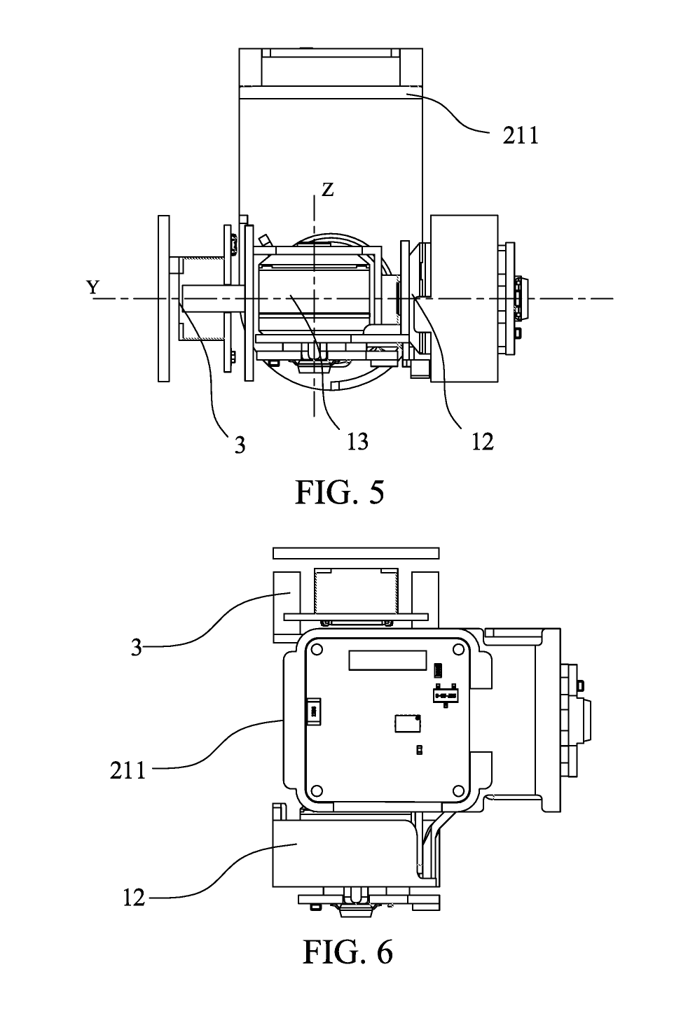

As shown in FIG. 1, the first fixing frame 21 comprises a base 211 and an extension arm 212 perpendicular to the base 211, wherein the first motor 11 is connected with the extension arm 212. As shown in FIG. 4, FIG. 5 and FIG. 6, the carrier 3, the second motor 12 and the third motor 13 are located below the base 211. Through the above arrangement, most or even all of the first motor 11, the second motor 12 and the third motor 13 are under a projection of the base 211, which effectively reduces a size of the three-axis gimbal in a horizontal direction and is beneficial to miniaturization.

As shown in FIG. 5, the second motor 12, the third motor 13 and the carrier 3 are successively arranged along the same plane. Through the position arrangement of the carrier 3, the structure is further compressed.

As shown in FIG. 1, the three-axis gimbal further comprises a first magnetic-control board 41, a second magnetic-control board 42 and a third magnetic-control board 43, wherein: the first motor 11 and the first magnetic-control board 41 are fixed at two sides of the first fixing frame 21; the second motor 12 and the second magnetic-control board 42 are fixed at two sides of the second fixing board 22; and, the third motor 13 and the third magnetic-control board 43 are fixed at two sides of the third fixing board 23.

Preferably, a control board 5 is arranged on the first fixing board 21. The carrier 3, the control board 5, the first magnetic-control board 41, the second magnetic-control board 42, and the third magnetic-control board 43 are electrically connected through a flexible printed circuit board. Through the flexible printed circuit board, wiring becomes convenient and assembly efficiency is increased.

According to the first preferred embodiment, the carrier 3 is a camera unit. Certainly, the carrier 3 can be other related components.

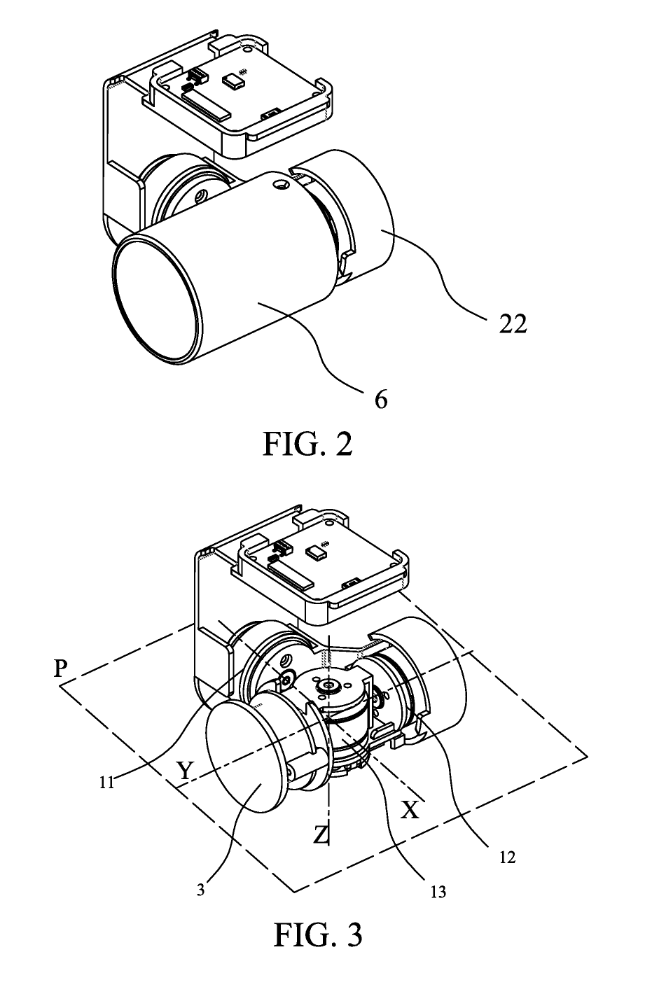

According to the first preferred embodiment, as shown in FIG. 2, a protective casing 6 covers outer sides of the carrier 3 and the third motor 13.

With the rotation of the motors, a position relationship of the three-axis gimbal will change. In the first preferred embodiment, the position relationship of the three-axis gimbal is limited in the initial state.

### Second Preferred Embodiment

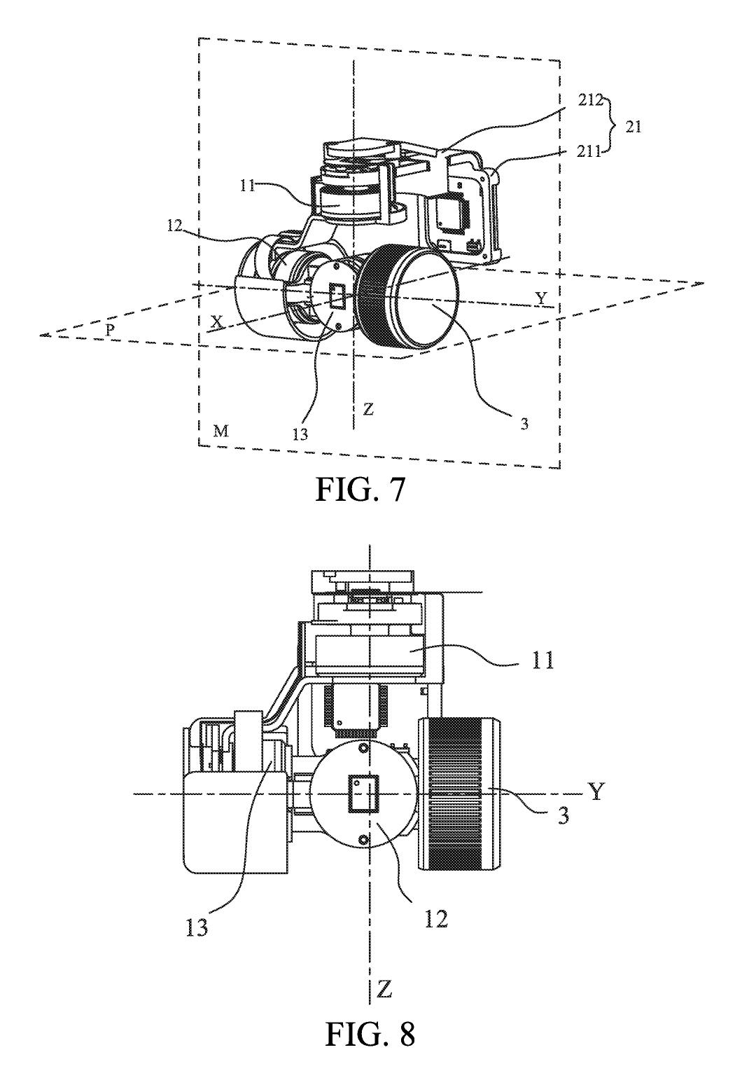

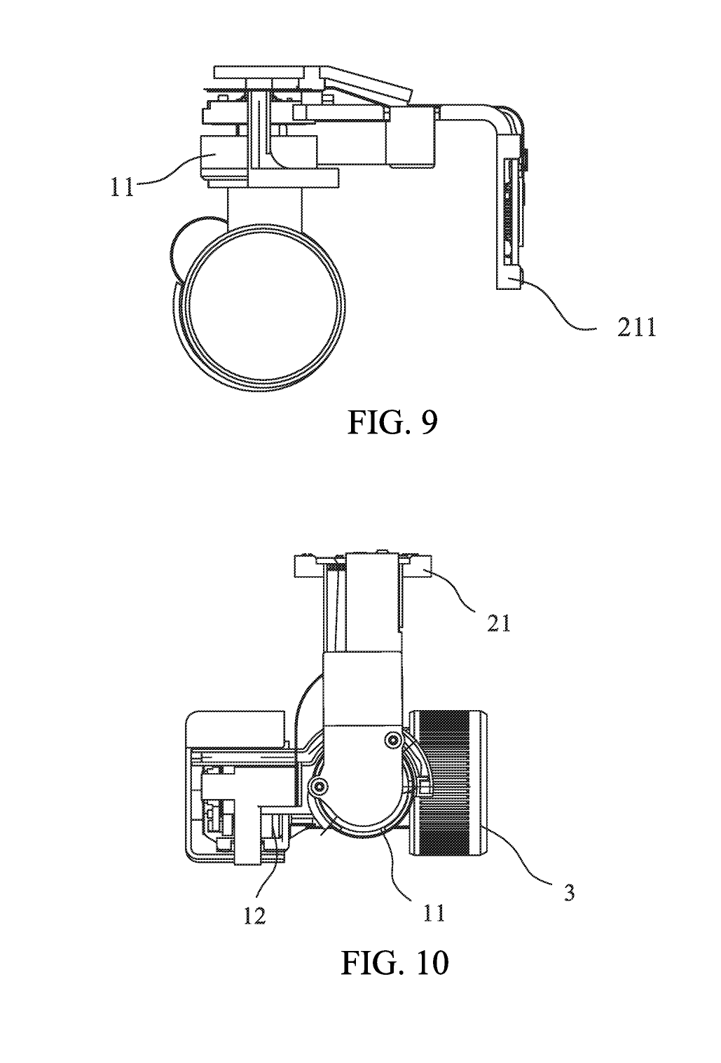

As shown in FIG.7-FIG. 10, the second preferred embodiment is different from the first preferred embodiment in changes of the first motor 11 and the third motor 13, and therefore an arrangement of the motors is changed.

As shown in FIG. 7, according to the second preferred embodiment, through the first motor 11, a rotation around an axis “Z” of the first motor 11 is realized; through the second motor 12, a rotation around an axis “Y” of the second motor 12 is realized; through the third motor 13, a rotation around an axis “X” of the third motor 13 is realized. In the first preferred embodiment, the axis of the first motor 11 is the axis “X” and the axis of the third motor 13 is the axis “Z”, that is to say the axes of the first motor 11 and the third motor 13 are swapped.

As shown in FIG. 7, the axis “Z” of the first motor 11, the axis “Y” of the second motor 12 and the axis “X” of the third motor 13 are perpendicular to each other. The axis “Y” of the second motor 12 is parallel to the axis of the carrier 3, and the axis “X” of the third motor 13 is perpendicular to the first fixing frame 21. Preferably, the axis “Y” of the second motor 12 and the axis of the carrier 3 are coaxial. Through the above arrangement of the first motor 11, the second motor 12 and the third motor 13, a stability of the carrier 3 is increased. When the carrier 3 is a camera unit, a shooting stability is greatly increased.

As shown in FIG. 7 and FIG. 8, according to the second preferred embodiment, the axis “Z” of the first motor 11 is perpendicular to the axis “Y” of the second motor 12, and the two axes are located in the same plane “M”, so as to realize the rational arrangement of the axis “Z” of the first motor 11 and the axis “Y” of the second motor 12, eliminate a distance deviation of the planes where the two axes are located and reduce a control difficulty of the motors. The axis “X” of the third motor 13 and the axis of the second motor 12 are located in the plane “P”, and the axis “X” of the third motor 13 is perpendicular to the plane “M”.

Preferably, the axis “Z” of the first motor 11 is arranged to be in a vertical state. Under an initial state, the plane “M” serves as a vertical plane and the plane “P” serves as a horizontal plane. The axis “Z” of the first motor 11 is arranged to be located in the vertical plane, that is to say both of the axis “X” and the axis “Y” are initially arranged horizontally, which simplifies a coordinate system and reduces the control difficulty of the motors.

Implementation principles of other parts of the second preferred embodiment are same as that of the first preferred embodiment, and thus not described in detail.

### Third Preferred Embodiment

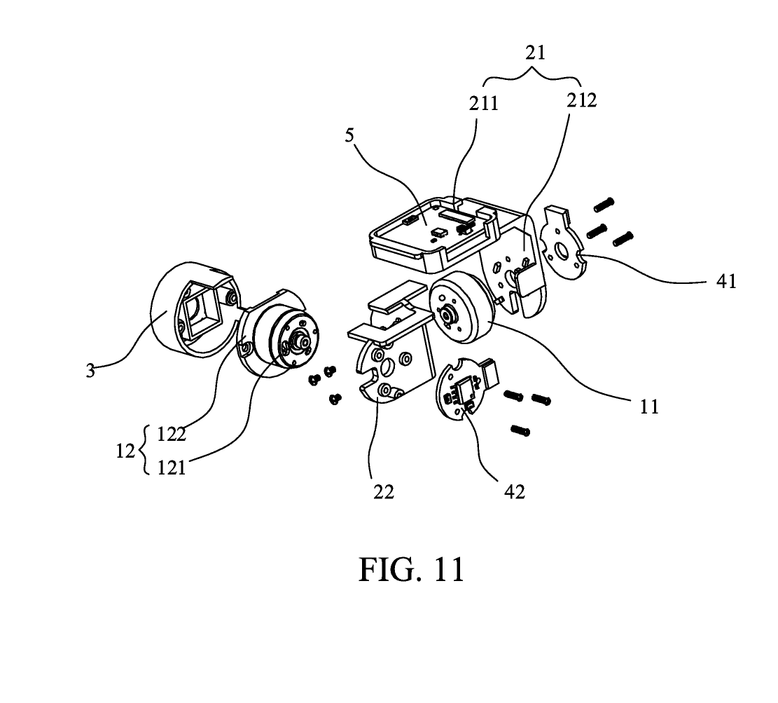

As shown in FIG. 11-FIG. 15, according to a third preferred embodiment, the present invention provides a two-axis gimbal, comprising a carrier 3, a first fixing frame 21, a second fixing frame 22, a first motor 11 and a second motor 12.

As shown in FIG. 11, the first motor 11 is connected respectively with the first fixing frame 21 and the second fixing frame 22, and is configured to drive the second fixing frame 22 to rotate relative to the first fixing frame 21; the second motor 12 is connected respectively with the second fixing frame 22 and the carrier 3, and is configured to drive the carrier 3 to rotate relative to the second fixing frame 22.

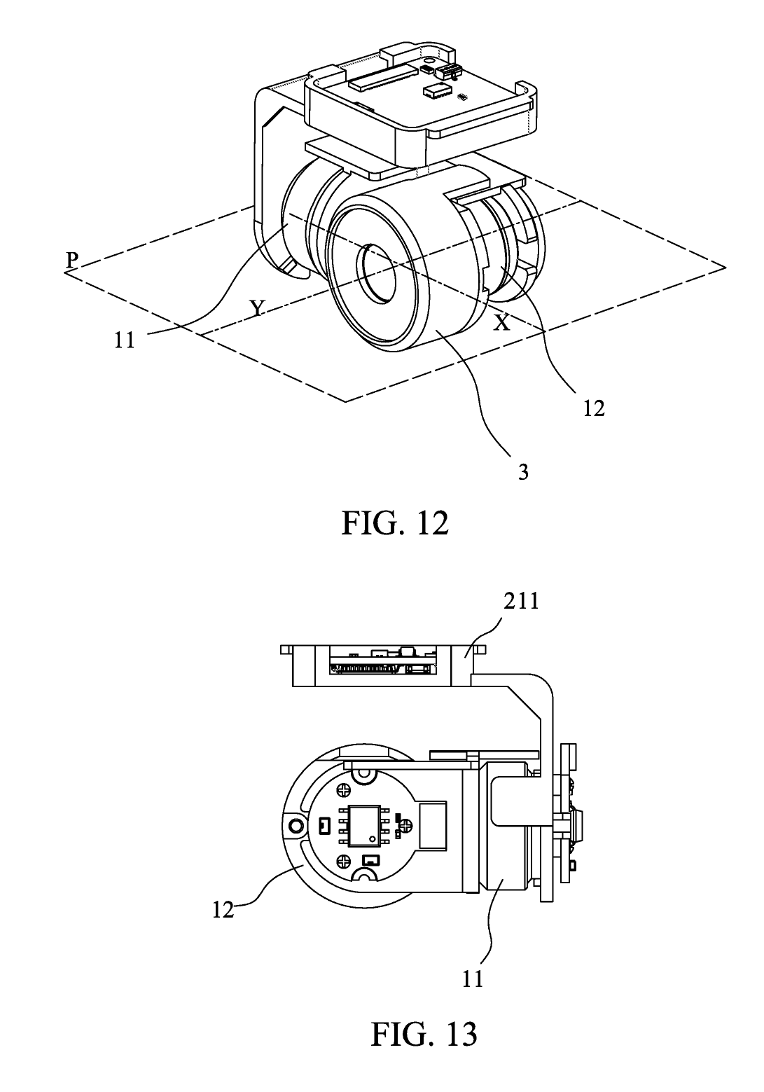

As shown in FIG. 12, through the first motor 11, a rotation around an axis “X” of the first motor 11 is realized; through the second motor 12, a rotation around an axis “Y” of the second motor 12 is realized.

As shown in FIG. 11, a conventional motor comprises a stator and a rotor. According to the third preferred embodiment, a stator 121 of the second motor 12 is connected with the second fixing frame 22, and a rotor 122 of the second motor 12 is connected with the carrier 3. A relative rotation generates between the stator 121 and the rotor 122, so as to drive the carrier 3 to rotate. Moreover, a stator of the first motor 11 is connected with the first fixing frame 21, and a rotor of the first motor 11 is connected with the second fixing frame 22.

As shown in FIG. 12, the first motor 11 and the second motor 12 are arranged in a same plane “P”, wherein the first motor 11 and the second motor 12 can have slight deviation in a vertical direction as long as main bodies of the first motor 11 and the second motor 12 are located in the same plane “P”.

Through arranging the first motor 11 and the second motor 12 in the same plane, stacking of the first motor 11 and the second motor 12 in the vertical direction is avoided, which effectively decreases a thickness of the two-axis gimbal in the vertical direction. Therefore, a volume and a weight of the gimbal are decreased, which is beneficial to a control of the two-axis gimbal.

As shown in FIG. 12, according to the third preferred embodiment, the axis “X” of the first motor 11 is perpendicular to the axis “Y” of the second motor 12, and the two axes are located in the same plane “P”, so as to realize the rational arrangement of the axis “X” of the first motor 11 and the axis “Y” of the second motor 12, eliminate a distance deviation of the planes where the two axes are located and reduce a control difficulty of the motors.

Preferably, the axis “X” of the first motor 11 is located in a horizontal plane. Under an initial state, the plane “P” is namely the horizontal plane. The axis “X” of the first motor 11 is arranged to be located in the horizontal plane, that is to say both of the axis “X” and the axis “Y” are initially arranged horizontally, which simplifies a coordinate system and reduces the control difficulty of the motors.

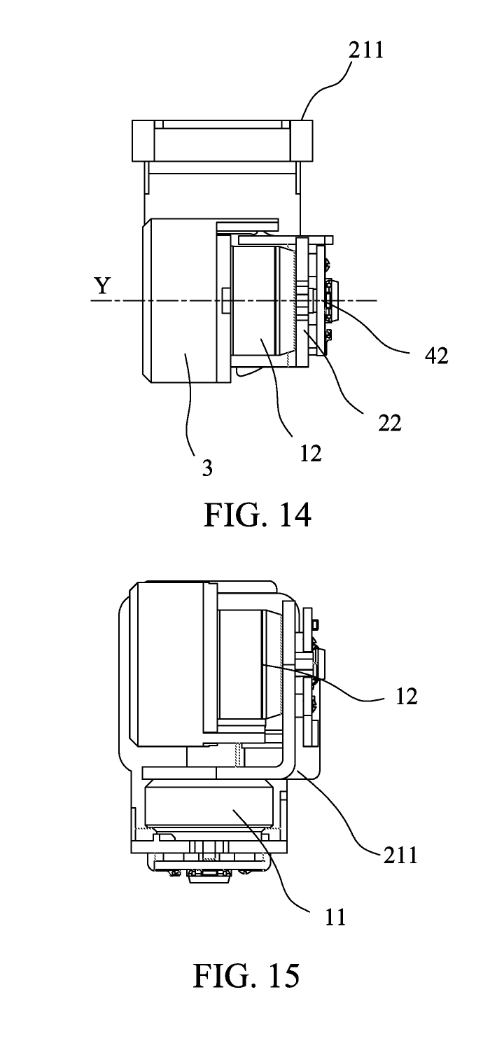

As shown in FIG. 11, the first fixing frame 21 comprises a base 211 and an extension arm 212 perpendicular to the base 211, wherein the first motor 11 is connected with the extension arm 212. As shown in FIG. 13, FIG. 14 and FIG. 15, the carrier 3 and the second motor 12 are located below the base 211. Through the above arrangement, most or even all of the first motor 11 and the second motor 12 are under a projection of the base 211, so that a size of the two-axis gimbal in a horizontal direction is reduced, which is beneficial to miniaturization.

As shown in FIG. 14, the second motor 12 and the carrier 3 are arranged along the axis “Y” of the second motor 12. Through the above arrangement of the carrier, the structure is further compressed. As shown in FIG. 12 or FIG. 14, the axis “Y” of the second motor 12 is parallel to an axis of the carrier 3. Preferably, the axis of the carrier 3 and the axis of the second motor 12 are coaxial. Through the above arrangement of the first motor 11 and the second motor 12, a stability of the carrier 3 is increased. When the carrier 3 is a camera unit, a shooting stability is greatly increased.

As shown in FIG. 11, the two-axis gimbal further comprises a first magnetic-control board 41 and a second magnetic-control board 42, wherein: the first motor 11 and the first magnetic-control board are fixed at two sides of the first fixing frame 21; the second motor 12 and the second magnetic-control board are fixed at two sides of the second fixing frame 22.

Preferably, a control board 5 is arranged on the first fixing frame 21. The carrier 3, the control board 5, the first magnetic-control board 41 and the second magnetic-control board 42 are electrically connected through a flexible printed circuit board. Through the flexible printed circuit board, wiring becomes convenient and assembly efficiency is increased.

According to the third preferred embodiment, the carrier 3 is the camera unit. Certainly, the carrier 3 can be other related components.

Preferred embodiments of the present invention are described above. However, for one skilled in the art, it should be understood that the preferred embodiments are exemplary only and the protection scope of the present invention is limited by the following claims. On the premise of not departing from the principle and the essence of the present invention, one skilled in the art can obtain various modifications and variations, and all of those medications and variations fall into the protection scope of the present invention.

What is claimed is:

1. A three-axis gimbal, comprising a carrier, a first fixing frame, a second fixing frame, a third fixing frame, a first motor, a second motor and a third motor, wherein:
the first motor is connected respectively with the first fixing frame and the second fixing frame, and is configured to drive the second fixing frame to rotate relative to the first fixing frame;
the second motor is connected respectively with the second fixing frame and the third fixing frame, and is configured to drive the third fixing frame to rotate relative to the second fixing frame;
the third motor is connected respectively with the third fixing frame and the carrier, and is configured to drive the carrier to rotate relative to the third fixing frame; and
an axis of the second motor is parallel to an axis of the carrier, and an axis of the third motor is perpendicular to the first fixing frame; an axis of the first motor, the axis of the second motor and the axis of the third motor are perpendicular to each other.

2. The three-axis gimbal, as recited in claim 1, wherein: the first fixing frame comprises a base and an extension arm perpendicular to the base; and the first motor is connected with the extension arm.

3. The three-axis gimbal, as recited in claim 2, wherein the axis of the third motor is perpendicular to the base.

4. The three-axis gimbal, as recited in claim 1, wherein the carrier is a camera unit.

5. The three-axis gimbal, as recited in claim 1, wherein the axis of the second motor and the axis of the carrier are coaxial.

6. The three-axis gimbal, as recited in claim 1, wherein the axis of the first motor is located in a horizontal plane.

7. The three-axis gimbal, as recited in claim 1, wherein the axis of the first motor is perpendicular to a horizontal plane.

8. The three-axis gimbal, as recited in claim 1, wherein:
a stator of the first motor is connected with the first fixing frame and a rotor of the first motor is connected with the second fixing frame;
a stator of the second motor is connected with the second fixing frame and a rotor of the second motor is connected with the third fixing frame; and
a stator of the third motor is connected with the third fixing frame and a rotor of the third motor is connected with the carrier.

9. The three-axis gimbal, as recited in claim 1, wherein a protective casing covers outer sides of the carrier and the third motor.

10. The three-axis gimbal, as recited in claim 1, wherein:
the three-axis gimbal further comprises a first magnetic-control board, a second magnetic-control board and a third magnetic-control board;
the first motor and the first magnetic-control board are fixed at two sides of the first fixing frame;
the second motor and the second magnetic-control board are fixed at two sides of the second fixing frame; and
the third motor and the third magnetic-control board are fixed at two sides of the third fixing frame.

11. The three-axis gimbal, as recited in claim 2, wherein:
the three-axis gimbal further comprises a first magnetic-control board, a second magnetic-control board and a third magnetic-control board;
the first motor and the first magnetic-control board are fixed at two sides of the first fixing frame;
the second motor and the second magnetic-control board are fixed at two sides of the second fixing frame; and
the third motor and the third magnetic-control board are fixed at two sides of the third fixing frame.

12. The three-axis gimbal, as recited in claim 10, wherein: a control board is arranged on the first fixing board; the carrier, the control board, the first magnetic-control board, the second magnetic-control board and the third magnetic-control board are electrically connected through a flexible printed circuit board.

13. A two-axis gimbal, comprising a carrier, a first fixing frame, a second fixing frame, a first motor and a second motor, wherein:
the first motor is connected respectively with the first fixing frame and the second fixing frame, and is configured to drive the second fixing frame to rotate relative to the first fixing frame;
the second motor is connected respectively with the second fixing frame and the carrier, and is configured to drive the carrier to rotate relative to the second fixing frame; and
an axis of the second motor is parallel to an axis of the carrier; and an axis of the first motor is perpendicular to the axis of the second motor.

14. The two-axis gimbal, as recited in claim 13, wherein: the first fixing frame comprises a base and an extension arm perpendicular to the base; the first motor is connected with the extension arm; the carrier and the second motor are located below the base; the axis of the first motor is parallel to the base.

15. The two-axis gimbal, as recited in claim 13, wherein the axis of the second motor and the axis of the carrier are coaxial.

16. The two-axis gimbal, as recited in claim 13, wherein the carrier is a camera unit.

17. The two-axis gimbal, as recited in claim 13, wherein the axis of the first motor is located in a horizontal plane.

18. The two-axis gimbal, as recited in claim 13, wherein:
a stator of the first motor is connected with the first fixing frame, and a rotor of the first motor is connected with the second fixing frame; and
a stator of the second motor is connected with the second fixing frame, and a rotor of the second motor is connected with the carrier.

19. The two-axis gimbal, as recited in claim 13, wherein:
the two-axis gimbal further comprises a first magnetic-control board and a second magnetic-control board;
the first motor and the first magnetic-control board are fixed at two sides of the first fixing frame; and
the second motor and the second magnetic-control board are fixed at two sides of the second fixing frame.

20. The two-axis gimbal, as recited in claim 19, wherein: a control board is arranged on the first fixing frame; the carrier, the control board, the first magnetic-control board and the second magnetic-control board are electrically connected through a flexible printed circuit board.
